(19) United States
(12) Patent Application Publication
(10) Pub. No.: US 2026/0247193 A1
(43) Pub. Date: Aug. 20, 2026

(54) METHOD AND DEVICE FOR MEASURING AND REPORTING FOR ANTENNA ARRAY ADJUSTMENT IN WIRELESS COMMUNICATION SYSTEM

(71) Applicant: Samsung Electronics Co., Ltd., Suwon-si, Gyeonggi-do (KR)

(72) Inventors: Kyoungmin PARK, Suwon-si (KR); Youngbum KIM, Suwon-si (KR); Hyunseok RYU, Suwon-si (KR); Junyung YI, Suwon-si (KR); Seunghoon CHOI, Suwon-si (KR)

(21) Appl. No.: 19/153,762

(22) PCT Filed: Feb. 7, 2024
(86) PCT No.: PCT/KR2024/001810

§ 371 Date: Aug. 5, 2025

(30) Foreign Application Priority Data
Feb. 7, 2023 (KR) 10-2023-0016397

(51) Int. Cl. H04W 24/10

(52) U.S. Cl. CPC H04W 24/10

(57) ABSTRACT

The disclosure relates to a 5G or 6G communication system for supporting a higher data transmission rate. Specifically, the present disclosure relates to a method carried out by a user equipment (UE) in a wireless communication system, which may comprise the steps of: receiving, from a base station, resource configuration information including a plurality of reference signal resources, and report configuration information including one or more sub-configurations connected to the plurality of resources, wherein the plurality of reference signal resources are each associated with at least one spatial domain antenna configuration among predetermined spatial domain antenna configurations which are different from each other, and the one or more sub-configurations are each associated with one spatial domain antenna configuration among the at least predetermined spatial domain antenna configurations which are different from each other; receiving, from the base station, information for triggering all or some of the one or more sub-configurations; receiving a reference signal for channel measurement from the base station on the basis of a reference signal resource associated with the all or some sub-configurations; and transmitting, to the base station, a channel state information (CSI) report including the result of the channel measurement based on the reference signal.

### TECHNICAL FIELD

The disclosure relates to wireless communication and, more particularly, to a network energy/power saving technique.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 50 mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IloT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

With the advance of wireless communication systems as described above, various services can be provided, and accordingly there is a need for ways to effectively provide these services.

### DISCLOSURE OF INVENTION

### Technical Problem

Embodiments set forth herein are to provide a device and a method capable of effectively providing services in a wireless communication system.

### Solution to Problem

In accordance with the disclosure a method performed by a terminal in a wireless communication system may include: receiving resource configuration information including a plurality of reference signal resources and report configuration information including at least one sub-configuration connected to the plurality of resources from a base station, each of the plurality of reference signal resources being associated with at least one spatial domain antenna configuration among different predetermined spatial domain antenna configurations, and each of the at least one sub-configuration being associated with one spatial domain antenna configuration among the different at least predetermined spatial domain antenna configurations; receiving information for triggering all or some of the at least one sub-configuration from the base station; receiving a reference signal for channel measurement from the base station, based on a reference signal resource associated with all or some of the at least one sub-configuration, and transmitting a channel state information (CSI) report including a result of the channel measurement based on the reference signal to the base station.

In accordance with the disclosure, a method performed by a base station in a wireless communication system may include: transmitting resource configuration information including a plurality of reference signal resources and report configuration information including at least one sub-configuration connected to the plurality of resources to a terminal, each of the plurality of reference signal resources being associated with at least one spatial domain antenna configuration among different predetermined spatial domain antenna configurations, and each of the at least one sub-configuration being associated with one spatial domain antenna configuration among the different at least predetermined spatial domain antenna configurations; transmitting information for triggering all or some of the at least one sub-configuration to the terminal; transmitting a reference signal for channel measurement to the terminal, based on a reference signal resource associated with all or some of the at least one sub-configuration, and receiving a channel state information (CSI) report including a result of the channel measurement based on the reference signal from the terminal.

In accordance with the disclosure, a terminal in a wireless communication system may include: a transceiver; and a controller connected to the transceiver, wherein the controller may be configured to: receive resource configuration information including a plurality of reference signal resources and report configuration information including at least one sub-configuration connected to the plurality of resources from a base station, each of the plurality of reference signal resources being associated with at least one spatial domain antenna configuration among different predetermined spatial domain antenna configurations, and each of the at least one sub-configuration being associated with one spatial domain antenna configuration among the different at least predetermined spatial domain antenna configurations; receive information for triggering all or some of the at least one sub-configuration from the base station; receive a reference signal for channel measurement from the base station, based on a reference signal resource associated with all or some of the at least one sub-configuration; and transmit a channel state information (CSI) report including a result of the channel measurement based on the reference signal to the base station.

In accordance with the disclosure, a base station in a wireless communication system may include: a transceiver; and a controller connected to the transceiver, wherein the controller may be configured to: transmit resource configuration information including a plurality of reference signal resources and report configuration information including at least one sub-configuration connected to the plurality of resources to a terminal, each of the plurality of reference signal resources being associated with at least one spatial domain antenna configuration among different predetermined spatial domain antenna configurations, and each of the at least one sub-configuration being associated with one spatial domain antenna configuration among the different at least predetermined spatial domain antenna configurations; transmit information for triggering all or some of the at least one sub-configuration to the terminal; transmit a reference signal for channel measurement to the terminal, based on a reference signal resource associated with all or some of the at least one sub-configuration, and receive a channel state information (CSI) report including a result of the channel measurement based on the reference signal from the terminal.

### Advantageous Effects of Invention

Embodiments set forth herein provide a device and a method capable of effectively providing services in a wireless communication system.

Advantageous effects obtainable from the disclosure may not be limited to the above-mentioned effects, and other effects which are not mentioned herein may be clearly understood from the following description by those skilled in the art to which the disclosure pertains.

### BRIEF DESCRIPTION OF DRAWINGS

FIG. 1 illustrates a phased base station energy saving procedure according to an embodiment of the disclosure.

FIG. 2 illustrates reference signal transmission and reception, measurement, and reporting for performing spatial-domain energy saving according to an embodiment of the disclosure.

FIG. 3 illustrates reference signal transmission and reception, measurement, and reporting for performing frequency/spatial-domain energy saving according to an embodiment of the disclosure.

FIG. 4 illustrates reference signal transmission and reception, measurement, and reporting for performing frequency/spatial-domain energy saving according to an embodiment of the disclosure.

FIG. 5 illustrates reference signal transmission and reception, measurement, and reporting for performing frequency/spatial-domain energy saving according to an embodiment of the disclosure.

FIG. 6 illustrates a spatial-domain energy saving measurement configuration through a common reference signal according to an embodiment of the disclosure.

FIG. 7 illustrates a common reference signal-based measurement value reporting method according to an embodiment of the disclosure.

FIG. 8 illustrates a structure of a base station according to an embodiment of the disclosure.

FIG. 9 illustrates a structure of a UE according to an embodiment of the disclosure.

### MODE FOR THE INVENTION

Hereinafter, the operation principle of the disclosure will be described in detail in conjunction with the accompanying drawings. In describing the disclosure below, a detailed description of known functions or configurations will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, LTE or LTE-A systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure. Herein, it will be understood that each block of the flowchart illustrations, and combinations of blocks in the flowchart illustrations, can be implemented by computer program instructions.

These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved. As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

In the following description of the disclosure, terms and names defined in 5GS and NR standards, which are the standards specified by the 3rd generation partnership project (3GPP) group among the existing communication standards, will be used for the sake of descriptive convenience. However, the disclosure is not limited by these terms and names, and may be applied in the same way to systems that conform other standards. For example, the disclosure may be applied to the 3GPP 5GS/NR (5th generation mobile communication standards).

To meet the demand for wireless data traffic having increased since deployment of 4th generation (4G) communication systems, efforts have been made to develop an improved 5th generation (5G) or pre- 5G communication system. Therefore, the 5G or pre- 5G communication system is also called a “beyond 4G network” communication system or a “post long term evolution (post LTE)” system.

The 5G communication system is considered to be implemented in ultrahigh frequency (mmWave) bands, (e.g., 60 GHZ bands) so as to accomplish higher data rates. To decrease propagation loss of the radio waves and increase the transmission distance of radio waves in the ultrahigh frequency bands, beamforming, massive multiple-input multiple-output (massive MIMO), full dimensional MIMO (FD-MIMO), array antenna, analog beam forming, large scale antenna techniques are under discuss ion in the 5G communication systems.

In addition, in the 5G communication system, technical development for system network improvement is under way based on evolved small cells, advanced small cells, cloud radio access networks (cloud RANs), ultra-dense networks, device-to-device (D2D) communication, wireless backhaul, moving network, cooperative communication, coordinated multi-points (CoMPs), reception-end interference cancellation, and the like.

In the 5G system, hybrid FSK and QAM modulation (FQAM) and sliding window superposition coding (SWSC) as an advanced coding modulation (ACM) scheme, and filter bank multi carrier (FBMC), non-orthogonal multiple access (NOMA), and sparse code multiple access (SCMA) as an advanced access technology have also been developed.

The 5G system is considering supports for more various services as compared to the conventional 4G system. For example, the most representative service may include a ultrawide band mobile communication service (enhanced mobile broad band (eMBB)), an ultrahigh reliable/low latency communication service (ultra-reliable and low latency communication (URLLC)), a massive device-to-device communication service (massive machine type communication (mMTC)), and a next-generation broadcast service (evolved multimedia broadcast/multicast service (eMBMS)). A system providing the URLLC service may be referred to as a URLLC system, and a system providing the eMBB service may be referred to as an eMBB system. The terms “service” and “system” may be interchangeably used.

Among these services, the URLLC service is a service that is newly considered in the 5G system, in contrast to the existing 4G system, and requires to meet ultrahigh reliability (e.g., packet error rate of about 10-5) and low latency (e.g., about 0.5 msec) conditions as compared to the other services. To meet these strict conditions required therefor, the URLLC service may need to apply a shorter transmission time interval (TTI) than the eMBB service, and various operating schemes employing the same are now under consideration.

The Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through a connection with a cloud server, etc. has emerged. As technology elements, such as “sensing technology”, “wired/wireless communication and network infrastructure”, “service interface technology”, and “security technology” have been demanded for IoT implementation, a sensor network, a machine-to-machine (M2M) communication, machine type communication (MTC), and so forth have recently been researched.

Such an IoT environment may provide intelligent Internet technology (IT) services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

In line with this, various attempts have been made to apply the 5G communication system to IoT networks. For example, technologies such as a sensor network, machine type communication (MTC), and machine-to-machine (M2M) communication are implemented by beamforming, MIMO, and array antenna techniques that are 5G communication technologies. Application of a cloud radio access network (cloud RAN) as the above-described big data processing technology may also be considered an example of convergence of the 5G technology with the IoT technology.

The disclosure relates to a network energy/power saving technique of performing power on/off by a unit of an antenna element or a unit of an antenna element combination.

The disclosure proposes a technique for determining whether to activate each antenna element according to a required throughput, link quality, or the like of UEs connected through a base station in operating an antenna array installed in the base station.

According to an embodiment of the disclosure, the base station may power off the entirety or a portion of the antenna array according to a channel state and the communication state of a connected UE, and may also quickly switch the antenna array to be powered on when necessary.

According to an embodiment of the disclosure, the technique enables flexible power saving and energy saving of the base station compared to existing techniques, and thus is expected to support high energy efficiency compared to the existing techniques.

The technique proposed in the disclosure mainly includes the following operations.

Operation 1. Time-domain energy saving determination operation of determining whether it is possible to switch the base station or a node to a power saving mode or to be powered off
In operation 1, the base station may determine (or identify) whether it is possible to switch any circuit in charge of transmission and reception of the node, any circuit in charge of transmission, any circuit in charge of data transmission and reception and RS transmission and reception, or any circuit in charge of data transmission and RS transmission to the power saving mode or to be powered off.
The power saving mode refers to a mode in which the base station is configured to use lower power than power used to support best performance supportable by the base station, and may be implemented by stopping supporting some functions of the base station or the node.

Operation 2. Frequency-domain energy saving determination operation of determining whether it is possible to switch a circuit in charge of a portion of a band handled by the base station or the node to the power saving mode or to be powered off
When it is determined in operation I not to perform time-domain energy saving, the base station or the node may determine whether to perform frequency-domain energy saving.
When frequency-domain energy saving is determined, the base station may support all functions supported in a normal mode, but a maximum bandwidth supportable for each UE may be reduced.

Operation 3. Spatial-domain energy saving determination operation of determining whether it is possible to switch a circuit in charge of some antenna elements among array antennas installed in the base station or the node to the power saving mode or to be powered off
When the base station does not perform time-domain energy saving and additional energy saving or power saving is required even while performing frequency-domain energy saving, that is, additional power or energy saving is required in a situation of not using the maximum bandwidth, the base station may review and determine whether to perform spatial-domain energy saving.

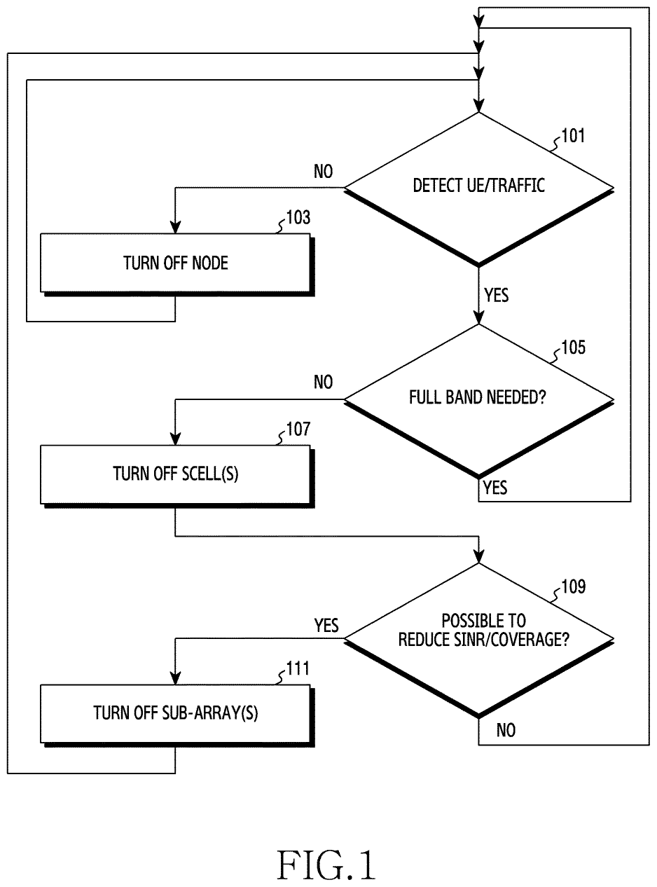

FIG. 1 illustrates a phased base station energy saving procedure according to an embodiment of the disclosure.

FIG. 1 shows an example of a network energy saving procedure of performing the foregoing three operations. In the example, a base station may perform spatial-domain energy saving only when frequency-domain energy saving is performed.

In operation 101, the base station or a node may determine whether a UE or traffic is detected. For example, the base station may determine whether the UE is camping on the base station or whether traffic is being transmitted to or received from the UE or another node.

When no UE or traffic is detected, the base station or node may be turned off in operation 103. As described above, the base station or the node may perform time-domain energy saving of determining whether it is possible to switch the base station or the node to the power saving mode or to be powered off.

For example, the base station may switch any circuit in charge of transmission and reception of the node, any circuit in charge of transmission, any circuit in charge of data transmission and reception and RS transmission and reception, or any circuit in charge of data transmission and RS transmission to the power saving mode or to be powered off.

When the UE or traffic is detected, the base station or the node may determine whether a maximum bandwidth is required in operation 105. That is, when not performing time-domain energy saving to provide a service for the UE or to transmit and receive the traffic, the base station or the node may determine whether to operate at the maximum bandwidth.

That is, the base station or the node may determine whether to perform a frequency-domain energy saving operation.

When it is not necessary to operate at the maximum bandwidth, the base station or the node may stop an operation of a secondary node (scell) in operation 107. However, the disclosure is not limited to this example, and the activated bandwidth may be changed or reduced.

In operation 109, the base station or the node may determine whether to reduce a signal-to-interference plus noise ratio (SINR)/coverage. That is, the base station or the node may determine whether to perform a spatial-domain energy saving operation.

According to an embodiment of the disclosure, the spatial-domain energy saving operation may include an operation of switching in charge of some antenna elements among array antennas installed in the base station or the node to the power saving mode or to be powered off. However, the disclosure is not limited to this example.

When additional power or energy saving is needed in a situation of not using the maximum bandwidth, the base station or the node may review and determine whether to perform spatial-domain energy saving.

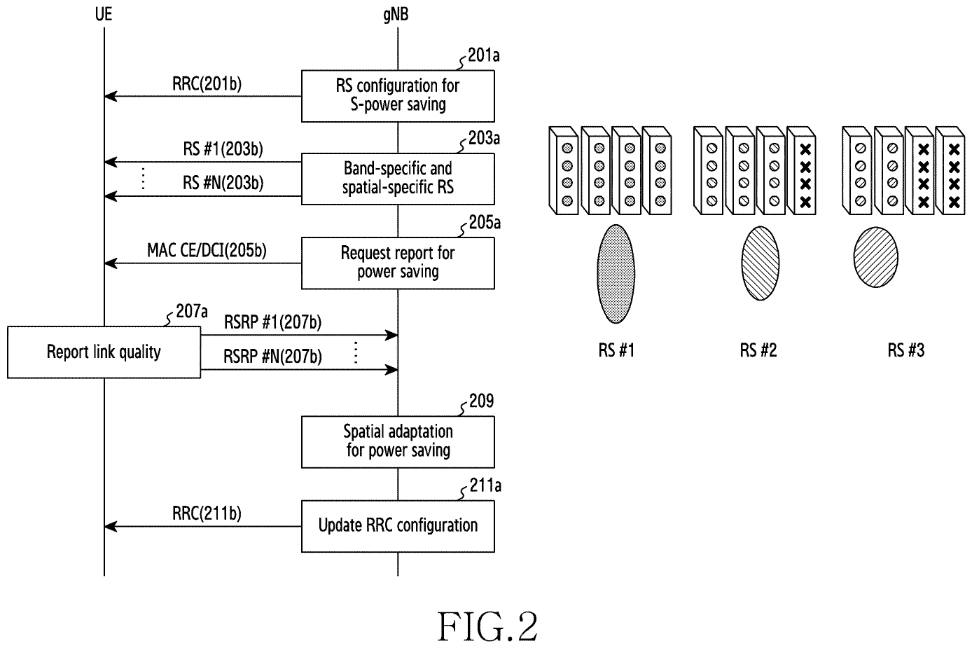

FIG. 2 illustrates reference signal transmission and reception, measurement, and reporting for performing spatial-domain energy saving according to an embodiment of the disclosure.

FIG. 2 shows an example of reference signal transmission, measurement, and reporting for determining whether to perform spatial-domain energy saving in the foregoing operation. A base station may transmit a first reference signal RS #1 for measuring link quality when all antenna elements included in an antenna array are used by using all antenna elements, may transmit a second reference signal RS #2 for measuring link quality when performing a first spatial-domain energy saving option by using only some antenna elements, and may transmit a third reference signal RS #3 for measuring link quality when performing a second spatial-domain energy saving option by using only some other antenna elements. A UE may measure and report link quality with respect to each of RS #1, RS #2, and RS #3, and the base station may determine an antenna element combination necessary for communication with the UE, based on the link quality.
In the foregoing operation, the reference signals RS #1, RS #2, and RS #3 transmitted by the base station may be a single or two-port RS for RSRP measurement, for example, a single/two-port CSI-RS.
Alternatively, some or all of the reference signals may be a multi-port RS, for example, a multi-port CSI-RS, in which case the UE may omit to measure and report some of a PMI or a CQI with respect to the reference signals, or may measure and report multi-port RSRP instead of existing PMI and CQI reporting. Multi-port RSRP is a value expressing the link quality of the channel as a quantity, for example, L1-RSRP or L3-RSRP, after the UE measures a multi-port RS to obtain channel information.
In reporting the link quality, the UE may report link quality with respect to all reference signals configured and received, that is, RS #1, RS #2, and RS #3, or may report link quality only with respect to an RS that satisfies a specific condition, for example, ‘n’ RSs with the best link quality or ‘m’ RSs with a link quality greater than a preset threshold. When reporting link quality only with respect to some reference signals as described above, the UE may also report information indicating which reference signal's link quality the report is about, for example, a reference signal reference index.

Referring to FIG. 2, in operation 201a, the base station may determine a reference signal (RS) configuration for spatial-domain energy saving (spatial-domain power saving), and in operation 201b, the base station may provide the determined RS configuration to the UE through a radio resource control (RRC) message.

In operation 203a, the base station may determine a band-specific RS and/or a spatial-specific RS, and in operation 203b, the base station may transmit a plurality of RSs (e.g., the foregoing RS #1, RS #2, and RS #3) to the UE. Alternatively, the base station may transmit the RSS (e.g., the foregoing RS #1, RS #2, and RS #3) to the UE on a plurality of RS resources. In operation 205a, the base station may determine whether to request a report for power saving, and in operation 205b, the base station may request the report through a media access control control element (MAC CE) or downlink control information (DCI).

In operation 207a, the UE may transmit a plurality of reference signal received powers (RSRPs) 207b with respect to the plurality of RSs through link quality reporting.

In reporting link quality, the UE may report link quality with respect to all reference signals configured and received, that is, RS #1, RS #2, and RS #3, or may report link quality only with respect to an RS that satisfies a specific condition, for example, ‘n’ RSs with the best link quality or ‘m’ RSs with a link quality greater than a preset threshold.

In operation 209, the base station may perform spatial adaptation for power saving. For example, as described above, the base station may determine an antenna element combination necessary for communication with the UE.

In operation 211a, the base station may update the RRC configuration for the spatial adaptation, and in operation 211b, the base station may provide the updated RRC configuration to the UE with via an RRC message.

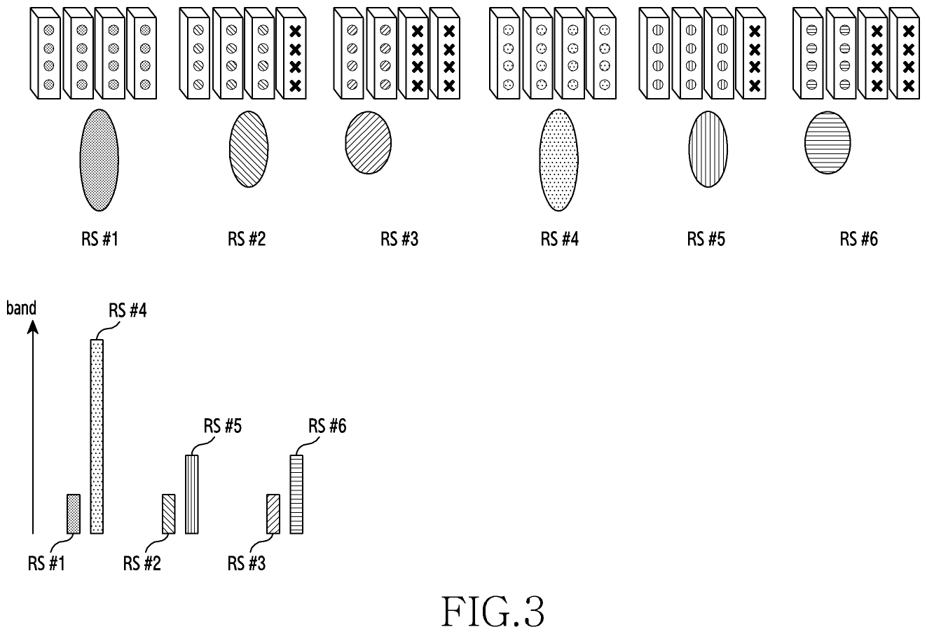

FIG. 3 illustrates reference signal transmission and reception, measurement, and reporting for performing frequency/spatial-domain energy saving according to an embodiment of the disclosure.

According to a method different from those of FIG. 1 and FIG. 2, a base station may simultaneously determine whether to perform frequency-domain energy saving and spatial-domain energy saving. FIG. 3 shows an example of a reference signal configured and transmitted for the base station to simultaneously determine whether to perform frequency-domain energy saving and spatial-domain energy saving.

According to an embodiment, some, for example, RS #4, among reference signals for measuring link quality when the base station uses the entire antenna array may be transmitted for measuring link quality when the entire band is used, and another reference signal, for example, RS #1, may be transmitted for measuring link quality when only a portion of the band is used.

The base station may determine whether to perform frequency-domain energy saving by comparing the link qualities with respect to RS #1 and #4. Further, the base station may simultaneously determine whether to apply frequency-domain energy saving and whether to apply spatial-domain energy saving by comparing link qualities with respect to RS #2, #3, #5, and #6 transmitted using only some antenna elements of the antenna array with the link qualities with respect to RS #1 and #4.

In addition, as RS #1 and RS #4, RS #2 and RS #5, and RS #3 and RS #6, each of which uses the same antenna element combination, are transmitted with different bandwidths, the base station may compare the link qualities with respect to the corresponding reference signals to determine an appropriate bandwidth for each antenna element combination used by the base station.

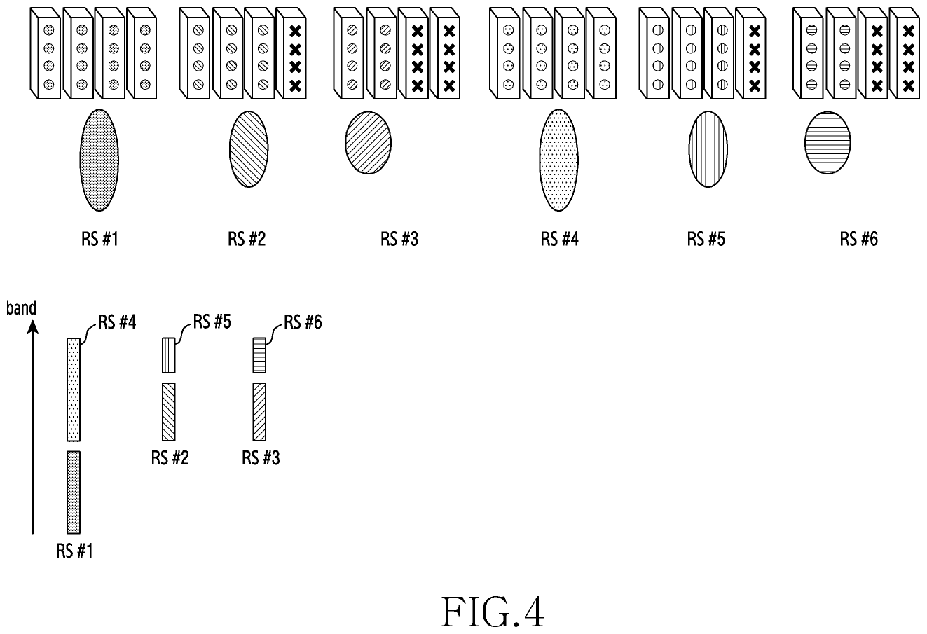

FIG. 4 illustrates reference signal transmission and reception, measurement, and reporting for performing frequency/spatial-domain energy saving according to an embodiment of the disclosure.

According to an embodiment, a base station may transmit reference signals using the same antenna elements in different bands, thereby providing a frequency selection or band selection function when determining whether to perform frequency-domain energy saving. Referring to FIG. 4, both RS #1 and RS #4 use all antenna elements but are transmitted in different bands, both RS #2 and RS #5 use some antenna elements but are transmitted in different bands, and both RS #3 and RS #6 also use some antenna elements but are transmitted in different bands.

The base station may perform frequency selection or band selection by comparing link qualities with respect to the reference signals. That is, the base station may compare the link qualities with respect to the reference signals to determine a frequency band to use when performing frequency-domain energy saving, and may thus select a most appropriate frequency band when performing frequency-domain energy saving.

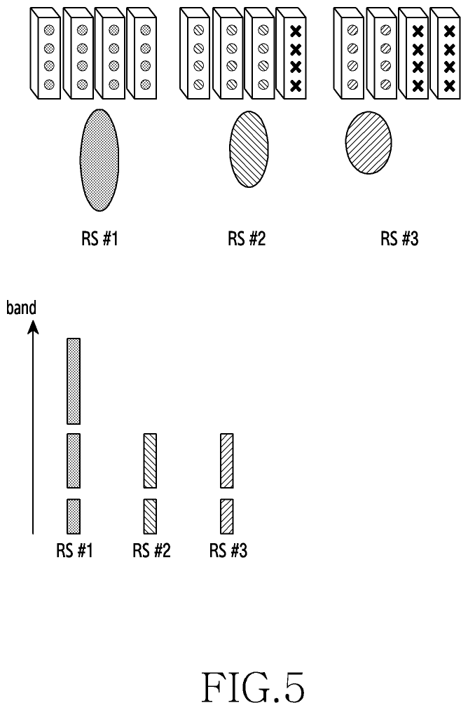

FIG. 5 illustrates reference signal transmission and reception, measurement, and reporting for performing frequency/spatial-domain energy saving according to an embodiment of the disclosure.

According to an embodiment, a base station may transmit each reference signal through a plurality of bands. Through this transmission method, the base station may perform frequency selection or band selection. Referring to FIG. 5, RS #1 may be transmitted in three frequency bands, and RS #2 and RS #3 may be transmitted in two frequency bands. The frequency bands in which RS #2 and RS #3 are transmitted may be the same or different.

In the foregoing examples of FIG. 3 to FIG. 5, in common, a reference signal for spatial-domain energy saving may be transmitted in a narrow radio band compared to a reference signal not for spatial-domain energy saving, because spatial-domain energy saving has a coverage reduction effect.

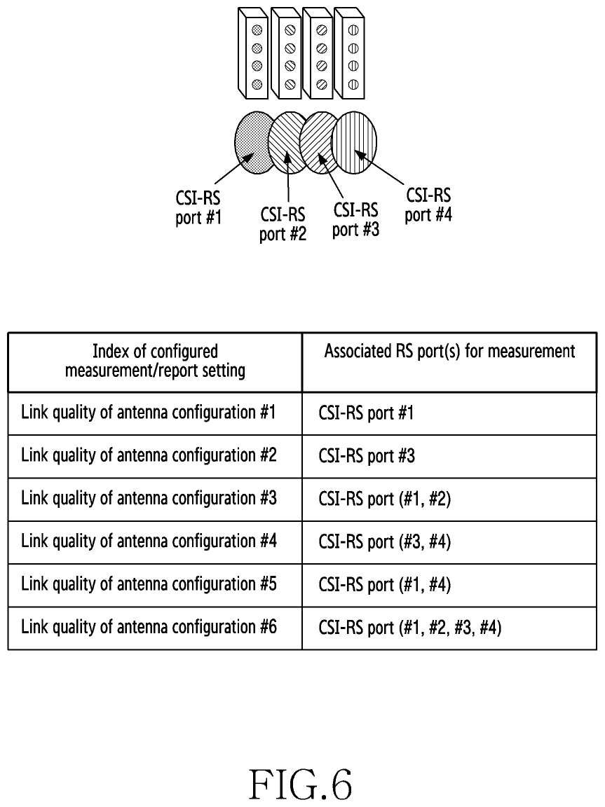

FIG. 6 illustrates a spatial-domain energy saving measurement configuration through a common reference signal according to an embodiment of the disclosure.

According to an embodiment, as another method of configuring and transmitting a reference signal and instructing a UE to perform measurement and reporting to determine whether to perform spatial-domain energy saving, a method of utilizing a common reference signal as in FIG. 6 is also possible.

Referring to FIG. 6, as a method of configuring and transmitting a common reference signal, a base station may utilize a multi-port RS. In configuration and transmission of FIG. 6, the base station may configure, set, and transmit a reference signal such that measurement of the UE for each port or each port set is a link quality measurement for an antenna element or an antenna element combination. Further, in the disclosure, each port or each port set may be each reference signal resource (which may be at least one resource) (e.g., a CSI-RS resource) or each reference signal resource set. Each reference signal resource set may include one or more reference signal resources. In the configuration and transmission of FIG. 6, the base station may configure, set, and transmit a reference signal such that measurement of the UE for each reference signal resource or each reference signal resource set is a link quality measurement for an antenna element or an antenna element combination. The measurement of the UE for each reference signal resource or each reference signal resource set may be measurement with respect to a reference signal transmitted on each reference signal resource or each reference signal resource set. Here, the antenna element or the antenna element combination may be an antenna array configuration (or an antenna sub-array configuration) on a spatial domain that the base station may configure for signal transmission.

According to an embodiment of the disclosure, when configuring the common reference signal such that the measurement of the UE for each port or each port set is the link quality measurement for the antenna element or antenna element combination, the base station may configure a reference signal or a reference signal combination that the UE needs to consider when measuring link quality for each antenna element or each antenna element combination, and may transmit corresponding information to the UE.

According to an embodiment, the configuration information about the reference signal or the reference signal combination that the UE needs to consider when measuring the link quality for each antenna element or each antenna element combination, which the base station transmits to the UE, may be transmitted in the form of a measurement configuration or a reporting configuration, and may be transmitted to the UE through RRC signaling, MAC CE signaling, or the like.

As illustrated in FIG. 6, a plurality of methods for measuring link quality for a common reference signal may be configured, in which case a configuration for each measurement method may include information about a reference signal that the UE needs to use when measuring link quality. The configuration information about the reference signal may be a portion of the common reference signal received by the UE, for example, a portion of a common reference signal port or a portion of a common reference signal resource element.

In measuring link quality according to the foregoing configuration, the UE may measure link quality in the form of a CQI, L1-RSRP, L1-SINR, L3-RSRP, L3-SINR, or the like, and may be configured (e.g., RRC) or indicated (e.g., through DCI or a MAC CE) by the base station to use one or more of the foregoing forms.

According to an embodiment of the disclosure, when the UE measures link quality in a form other than a CQI, the UE may define and measure link quality as a combination of multi-port RS signal reception power. The combination of multi-port RS signal reception power may be in the form of, for example, the average of reception power of signals corresponding to respective ports, a maximum value of reception power of signals corresponding to the respective ports, or a weighted sum of reception power of signals corresponding to the respective ports. However, the disclosure is not limited to the above examples.

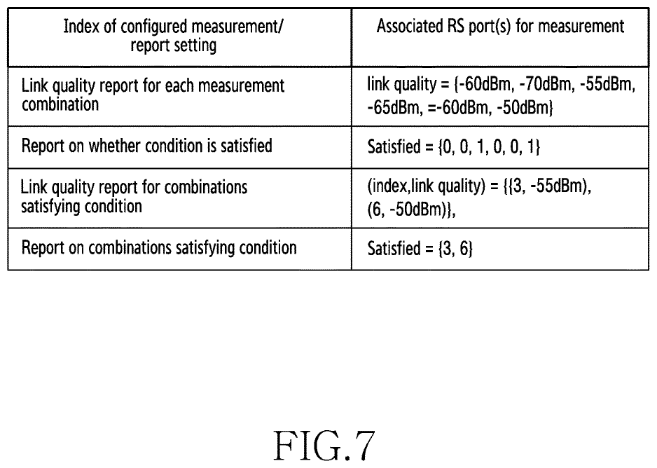

FIG. 7 illustrates a common reference signal-based measurement value reporting method according to an embodiment of the disclosure.

When reporting a measurement result, a UE may report a result for each measurement configuration at once or sequentially, and may also report all measurement values or may select and report some measurement values.

In addition, when reporting a measurement value, the UE may also report information indicating a measurement configuration by which a reported link quality value is measured. Alternatively, the UE may report whether a measured link quality satisfies a preset condition without reporting the measured value, or may report information about a measurement configuration in which a result that satisfies the preset condition is shown. FIG. 7 shows an example of various reporting methods described above, in which link qualities of {−60 dBm, −70 dBm, −55 dBm, −65d Bm, −60 dBm, −50 dBm} are measured in order in six measurement configurations illustrated in FIG. 6, and the set condition is assumed as link quality <−60 dBm.

In the disclosure, a common reference signal may refer to a combination of reference signals configured to be commonly used by the UE for two or more link quality measurements. The common reference signal may be configured in the form of one reference signal resource, a plurality of reference signal resources, one reference signal resource set, or a plurality of reference signal resource sets. However, the disclosure is not limited to the above examples.

When a common reference signal is configured in the form of a plurality of reference signal resource sets, the UE may be configured to measure link quality through a combination of reference signals belonging to each reference signal resource set. When the common reference signal is configured and transmitted through the plurality of reference signal resource sets, the UE does not use a method of calculating link quality by combining measurement results between resources belonging to different reference signal resource sets, but calculates an independent result for each set and utilizes the result for reporting. For example, the UE may select various reporting methods shown in FIG. 7 for each set, and may perform reporting for each set.

A base station may configure a combination of antenna elements used for communication with each UE, configure a combination of transmission antenna elements used for DL communication with each UE, or configure a combination of antenna elements to be used for each channel and RS transmission or reception of each UE, based on a measurement result report of the UE, the base station can set.

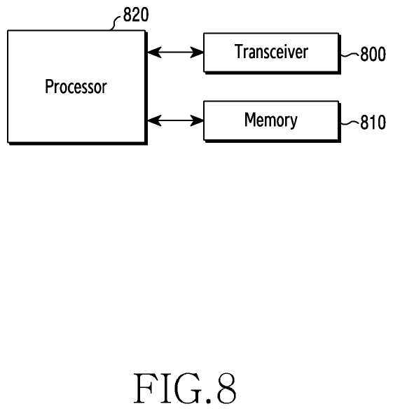

FIG. 8 illustrates a structure of a base station according to an embodiment of the disclosure.

As illustrated in FIG. 8, a base station of the disclosure may include a processor 820, a transceiver 800, and a memory 810. However, components of the base station are not limited to the above-described example. For example, the base station may include a larger or smaller number of components than the above-described components. In addition, the processor 820, the transceiver 800, and the memory 810 may be implemented in the form of a single chip.

According to an embodiment of the disclosure, the processor 820 may control a series of processes so that the base station can operate according to the above-described embodiments of the disclosure. For example, the processor 820 may control the components of the base station in order to perform the antenna array control methods according to the above-described embodiments. The processor 820 may control the components of the base station to perform the embodiments of the disclosure by executing the programs stored in the memory 810. In addition, the processor 820 may be an application processor (AP), a communication processor (CP), a circuit, an application-specific circuit, or at least one processor.

According to an embodiment of the disclosure, the transceiver 800 may transmit/receive signals with network entities, other base stations, or UEs. The signals transmitted/received with network entities, other base stations, or UEs may include control information and data. The transceiver 800 may include an RF transmitter configured to up-convert and amplify the frequency of transmitted signals, an RF receiver configured to low-noise-amplify received signals and down-convert the frequency thereof, and the like. However, this is only an embodiment of the transceiver 800, and the components of the transceiver 800 are not limited to the RF transmitter and the RF receiver, In addition, the transceiver 800 may receive signals through a radio channel, output the same to the processor 820, and transmit signals output from the processor 820 through the radio channel.

According to an embodiment of the disclosure, the memory 810 may store programs and data necessary for operations of the base station. In addition, the memory 810 may store control information or data included in signals transmitted/received by the base station. The memory 810 may include storage media such as a ROM, a RAM, a hard disk, a CD-ROM, and a DVD, or a combination of storage media. In addition, the memory 810 may include multiple memories. Furthermore, according to an embodiment, the memory 810 may store programs for executing the above-described antenna array control methods.

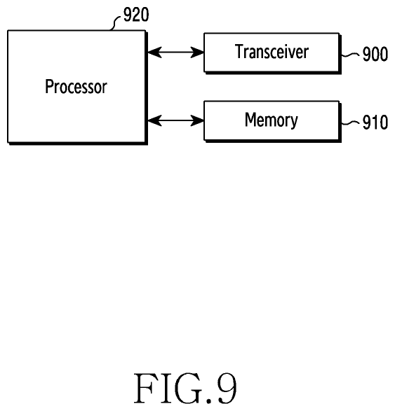

FIG. 9 illustrates a structure of a UE according to an embodiment of the disclosure.

As illustrated in FIG. 9, a UE of the disclosure may include a processor 920, a transceiver 900, and a memory 910. However, components of the UE are not limited to the above-described example. For example, the UE may include a larger or smaller number of components than the above-described components. In addition, the processor 920, the transceiver 900, and the memory 910 may be implemented in the form of a single chip.

According to an embodiment of the disclosure, the processor 920 may control a series of processes so that the UE can operate according to the above-described embodiments of the disclosure. For example, the processor 920 may control the components of the UE in order to perform methods for providing the antenna array control methods according to the above-described embodiments. The processor 920 may control the components of the UE to perform the embodiments of the disclosure by executing the programs stored in the memory 910. In addition, the processor 920 may be an application processor (AP), a communication processor (CP), a circuit, an application-specific circuit, or at least one processor.

According to an embodiment of the disclosure, the transceiver 900 may transmit/receive signals with network entities, other UEs, or base stations. The signals transmitted/received with network entities, other UEs, or base stations may include control information and data. The transceiver 900 may include an RF transmitter configured to up-convert and amplify the frequency of transmitted signals, an RF receiver configured to low-noise-amplify received signals and down-convert the frequency thereof, and the like. However, this is only an embodiment of the transceiver 900, and the components of the transceiver 900 are not limited to the RF transmitter and the RF receiver. In addition, the transceiver 900 may receive signals through a radio channel, output the same to the processor 920, and transmit signals output from the processor 920 through the radio channel.

According to an embodiment of the disclosure, the memory 910 may store programs and data necessary for operations of the UE. In addition, the memory 910 may store control information or data included in signals transmitted/received by the UE. The memory 910 may include storage media such as a ROM, a RAM, a hard disk, a CD-ROM, and a DVD, or a combination of storage media. In addition, the memory 910 may include multiple memories. Furthermore, according to an embodiment, the memory 910 may store programs for executing the above-described antenna array control methods.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1. A method performed by a user equipment (UE) in a wireless communication system, the method comprising:
receiving, from a base station, first configuration information on a channel state information reference signal (CSI-RS) resource and second configuration information on a CSI report including at least one sub-configuration for channel quality indicator (CQI) calculation associated with at least one antenna port sub-set;
receiving, from the base station, a reference signal for a channel measurement based on the first configuration information; and
transmitting, to the base station, the CSI report including a result of the channel measurement based on the at least one sub-configuration.

2. The method of claim 1, further comprising:
receiving, from the base station, information for activating the at least one sub-configuration-wherein measurement.

3. The method of claim2, wherein the information for activating the at least one sub-configuration is included in downlink control information (DCI) or a medium access control (MAC) control element (CE).

4. The method of claim 1, wherein each of the at least one sub-configuration indicates each of the at least one antenna port sub-set.

5. A method performed by a base station in a wireless communication system, the method comprising:
transmitting, to a user equipment (UE), first configuration information on a channel state information reference signal (CSI-RS) resource and second configuration information on a CSI report including at least one sub-configuration for channel quality indicator (CQI) calculation associated with at least one antenna port sub-set;
transmitting, to the UE, a reference signal for a channel measurement based on the first configuration information; and
receiving, from the UE, the CSI report including a result of the channel measurement based on the at least one sub-configuration.

6. The method of claim 5, further comprising:
transmitting, to the UE, information for activating the at least one sub-configuration.

7. The method of claim6, wherein the information for activating the at least one sub-configuration is included in downlink control information (DCI) or a medium access control (MAC) control element (CE).

8. The method of claim 5, wherein each of the at least one sub-configuration indicates each of the at least one antenna port sub-set. plurality

9. A user equipment (UE) comprising:
at least one transceiver;
at least one processor communicatively coupled to the at least one transceiver; and
at least one memory, communicatively coupled to the at least one processor, storing instructions executable by the at least one processor individually or in any combination to cause the UE to:
receive, from a base station, first configuration information on a channel state information reference signal (CSI-RS) resource and second configuration information on a CSI report including at least one sub-configuration for channel quality indicator (CQI) calculation associated with at least one antenna port sub-set,
receive, from the base station, a reference signal for a channel measurement based on the first configuration information, and
transmit, to the base station, the CSI report including a result of the channel measurement based on the at least one sub-configuration.

10. The UE of claim 9, wherein the instructions further cause the UE to:
receive, from the base station, information for activating the at least one sub-configuration.

11. The UE of claim 10, wherein the information for activating the at least one sub-configuration is included in downlink control information (DCI) or a medium access control (MAC) control element (CE).

12. The UE of claim 9, wherein each of the at least one sub-configuration indicates each of the at least one antenna port sub-set.

13. A base station comprising:
at least one transceiver;
at least one processor communicatively coupled to the at least one transceiver; and
at least one memory, communicatively coupled to the at least one processor, storing instructions executable by the at least one processor individually or in any combination to cause the base station to:
transmit, to a user equipment (UE), first configuration information on a channel state information reference signal (CSI-RS) resource and second configuration information on a CSI report including at least one sub-configuration for channel quality indicator (CQI) calculation associated with at least one antenna port sub-set,
transmit, to the UE, a reference signal for a channel measurement based on the first configuration information, and
receive, from the UE, the CSI report including a result of the channel measurement based on the at least one sub-configuration.

14. The base station of claim 13, wherein the instructions further cause the base station to:
transmit, to the UE, information for activating the at least one sub-configuration.

15. The base station of claim 14, wherein the information for activating the at least one sub-configuration is included in downlink control information (DCI) or a medium access control (MAC) control element (CE).

16. The base station of claim 13, wherein each of the at least one sub-configuration indicates each of the at least one antenna port sub-set.
